(19) United States
(12) Patent Application Publication
(10) Pub. No.: US 2025/0219721 A1
(43) Pub. Date: Jul. 3, 2025

(54) SYSTEMS AND METHODS FOR DELIVERY OF AN ATSC 3.0 FORMATTED SIGNAL VIA DBS SATELLITE LINK FOR POINT TO MULTI-POINT DISTRIBUTION

(71) Applicant: DISH Wireless L.L.C., Englewood, CO (US)

(72) Inventors: Paul A. Langer, Westminster, CO (US); David Zufall, Lone Tree, CO (US); Marcel Guajardo, Lakewood, CO (US); Darel Peacock, Cheyenne, WY (US); Jason Woodruff, Englewood, CO (US); Media Shakiba Johnsen, Denver, CO (US)

(21) Appl. No.: 18/399,292

(22) Filed: Dec. 28, 2023

(51) Int. Cl. H04B 7/185; H04L 5/00

(52) U.S. Cl. CPC H04B 7/18526; H04B 7/18513; H04L 5/0007

(57) ABSTRACT

A system includes one or more processors and a memory device storing a set of instructions that, when executed by the one or more processors, causes the system to: receive a ATSC 3.0 MPEG TS video feed via satellite over DVB-S2 at a satellite receiver at the remote location, the satellite receiver being associated with an ATSC 3.0 transmitter; and transmit the ATSC 3.0 MPEG TS video feed to ATSC 3.0 end user devices. The ATSC 3.0 MPEG TS video feed transmission is a multi-cast transmission with variable modulation encoding that includes multiple channels in a same transport stream. One channel of the multiple channels is encoded with more error protection and less resolution for transmission to mobile devices and another channel in the multiple channels, which may have the same content is encoded with less error correction and higher resolution for fixed devices.

### BACKGROUND

The Advanced Television Systems Committee (ATSC) sets Over the Air (OTA) Standards for digital High Definition Television (HD TV). ATSC 1.0 is legacy broadcast standard used for OTA stations in the United States, as well as Canada and Mexico. ATSC 3.0 is the new set of global standards for broadcast TV. ATSC 3.0 broadcasts HD TV signals over licensed spectrum and utilizes Internet Protocol (IP) transport. ATSC 3.0 is a suite of voluntary technical standards and practices that is fundamentally different from ATSC 1.0. Significantly, ATSC 3.0 is not backwards compatible with ATSC 1.0 so new transmission and reception equipment (e.g., satellite receiver, television, etc.) is required in order to implement ATSC 3.0. Legacy antennas will work for ATSC 3.0, though legacy tuners will not work for ATSC 3.0.

There is also a growing desire to be able to watch enhanced video content with improved image detail, contrast, and color gamut, as well listen to immersive audio with three dimensional sound. Additionally, there is a desire for robust services on mobile devices such as OTA television service on phones, tables, and the like. Furthermore, on demand capabilities are limited by the lack of ability for two-way interaction. There is a continuing need for a system that provides enhanced audio and video capabilities as well as other advanced mobile services and features. The present disclosure addresses this and other needs.

### BRIEF SUMMARY

The present disclosure relates to system for delivery of an ATSC 3.0 formatted signal, and particularly to a system for delivery of an ATSC 3.0 formatted signal via DBS satellite link for point to multi-point distribution.

Briefly stated, embodiments described herein are directed towards a satellite-based content delivery system with multiple ATSC 3.0 transmitters and integrated satellite receivers. The method includes generating ATSC 3.0 MPEG Transport Stream (TS) video feed at a head end location; encapsulating the ATSC 3.0 MPEG TS video feed into a DVB packet structure to be modulated onto a DVB-S2 carrier; sending the encapsulated ATSC 3.0 MPEG TS video feed via satellite over the DVB-S2 carrier to multiple satellite receivers at distributed locations; receiving the encapsulated ATSC 3.0 MPEG TS video feed at the multiple satellite receivers at distributed locations, each of the multiple satellite receivers being associated with an ATSC 3.0 transmitter; un-encapsulating the ATSC 3.0 MPEG TS video feed for use by multiple ATSC 3.0 transmitters; and transmitting the ATSC 3.0 MPEG TS video feed to ATSC 3.0 end user devices. The ATSC 3.0 MPEG TS video feed transmission includes multiple channels in a same transport stream, where one channel of the multiple channels is encoded with more error protection and less resolution for transmission to mobile devices and another channel in the multiple channels, which may have the same content is encoded with less error correction and higher resolution for fixed devices.

In some embodiments of the method for delivery of an ATSC 3.0 formatted signal via DBS satellite link for point to multi-point distribution, the transmission of the ATSC 3.0 MPEG TS video feed to the ATSC 3.0 end user devices employs Orthogonal Frequency-Division Multiplexing (OFDM). In another aspect of some embodiments, the transmission of the ATSC 3.0 MPEG TS video feed to the ATSC 3.0 end user devices employs ATSC 3.0 repeaters. In still another aspect of some embodiments, the transmission of the ATSC 3.0 MPEG TS video feed to the ATSC 3.0 end user devices supports MPEG-4 encoding. In yet another aspect of some embodiments, each ATSC 3.0 transmitter includes an omni-directional antenna.

In one or more embodiments of the method for delivery of an ATSC 3.0 formatted signal via DBS satellite link for point to multi-point distribution, at least one channel in the multiple channels is a back channel that supports a return path from an ATSC 3.0 end user device to an associated ATSC 3.0 transmitter. In another aspect of one or more embodiments, the back channel employs IP encapsulation of data with a return path via 5G cellular. In still another aspect of one or more embodiments, the ATSC 3.0 end user devices include mobile devices including one or more of smartphones, laptop computers, and mobile vehicles via an OBD2 port, and wherein the ATSC 3.0 end user devices include fixed devices including one or more of televisions, desktop computers, and other fixed display devices. In yet another aspect of one or more embodiments, the multiple channels of the ATSC 3.0 MPEG TS video feed transmission support interactive location services, custom advertisement insertion, and localized emergency notification services.

In other embodiments, one or more systems for delivery of an ATSC 3.0 formatted signal via DBS satellite link for point to multi-point distribution are disclosed. The system includes: a memory that stores computer executable instructions; and a processor that executes the computer executable instructions to: generate ATSC 3.0 MPEG TS video feed at head end location; encapsulate the ATSC 3.0 MPEG TS video feed into a DVB packet structure to be modulated onto a DVB-S2 carrier; send the encapsulated ATSC 3.0 MPEG TS video feed via satellite over DVB-S2 to multiple satellite receivers at distributed locations; receive the encapsulated ATSC 3.0 MPEG TS video feed at the multiple satellite receivers at distributed locations, each of the multiple satellite receivers being associated with an ATSC 3.0 transmitter; un-encapsulate the ATSC 3.0 MPEG TS video feed for use by multiple ATSC 3.0 transmitters; and transmit the ATSC 3.0 MPEG TS video feed to ATSC 3.0 end user devices. The ATSC 3.0 MPEG TS video feed transmission includes multiple channels in a same transport stream. One channel of the multiple channels is encoded with more error protection and less resolution for transmission to mobile devices and another channel in the multiple channels, which may have the same content is encoded with less error correction and higher resolution for fixed devices.

In some embodiments of the system for delivery of an ATSC 3.0 formatted signal via DBS satellite link for point to multi-point distribution, the transmission of the ATSC 3.0 MPEG TS video feed to the ATSC 3.0 end user devices employs Orthogonal Frequency-Division Multiplexing (OFDM). In another aspect of some embodiments, the transmission of the ATSC 3.0 MPEG TS video feed to the ATSC 3.0 end user devices employs ATSC 3.0 repeaters. In still another aspect of some embodiments, the transmission of the ATSC 3.0 MPEG TS video feed to the ATSC 3.0 end user devices supports MPEG-4 encoding. In yet another aspect of some embodiments, each ATSC 3.0 transmitter includes an omni-directional antenna.

In one or more embodiments of the system for delivery of an ATSC 3.0 formatted signal via DBS satellite link for point to multi-point distribution, at least one channel in the multiple channels is a back channel that supports a return path from an ATSC 3.0 end user device to an associated ATSC 3.0 transmitter. In another aspect of one or more embodiments, the back channel employs IP encapsulation of data with a return path via 5G cellular. In still another aspect of one or more embodiments, the ATSC 3.0 end user devices include mobile devices including one or more of smartphones, laptop computers, and mobile vehicles via an OBD2 port, and wherein the ATSC 3.0 end user devices include fixed devices including one or more of televisions, desktop computers, and other fixed display devices. In yet another aspect of one or more embodiments, the multiple channels of the ATSC 3.0 MPEG TS video feed transmission support interactive location services, custom advertisement insertion, and localized emergency notification services.

Additionally, in other embodiments, one or more systems for satellite-based content delivery are disclosed using an ATSC 3.0 transmitter and integrated satellite receiver. The system includes: a memory that stores computer executable instructions; and a processor that executes the computer executable instructions to: send an ATSC 3.0 MPEG TS video feed via satellite over DVB-S2 to a satellite receiver at a remote location; receive the ATSC 3.0 MPEG TS video feed at the satellite receiver at the remote location, the satellite receiver being associated with an ATSC 3.0 transmitter; and transmit the ATSC 3.0 MPEG TS video feed to ATSC 3.0 end user devices. The ATSC 3.0 MPEG TS video feed transmission is a multi-cast transmission with variable modulation encoding that includes multiple channels in a same transport stream. Notably, one channel of the multiple channels is encoded with more error protection and less resolution for transmission to mobile devices and another channel in the multiple channels, which may have the same content is encoded with less error correction and higher resolution for fixed devices.

In some embodiments of the system for delivery of an ATSC 3.0 formatted signal via DBS satellite link for point to multi-point distribution, the transmission of the ATSC 3.0 MPEG TS video feed to the ATSC 3.0 end user devices employs Orthogonal Frequency-Division Multiplexing (OFDM). In another aspect of some embodiments, the transmission of the ATSC 3.0 MPEG TS video feed to the ATSC 3.0 end user devices employs ATSC 3.0 repeaters. In still another aspect of some embodiments, the transmission of the ATSC 3.0 MPEG TS video feed to the ATSC 3.0 end user devices supports MPEG-4 encoding. In yet another aspect of some embodiments, each ATSC 3.0 transmitter includes an omni-directional antenna.

In one or more embodiments of the system for delivery of an ATSC 3.0 formatted signal via DBS satellite link for point to multi-point distribution, at least one channel in the multiple channels is a back channel that supports a return path from an ATSC 3.0 end user device to an associated ATSC 3.0 transmitter. In another aspect of one or more embodiments, the back channel employs IP encapsulation of data with a return path via 5G cellular. In still another aspect of one or more embodiments, the ATSC 3.0 end user devices include mobile devices including one or more of smartphones, laptop computers, and mobile vehicles via an OBD2 port, and wherein the ATSC 3.0 end user devices include fixed devices including one or more of televisions, desktop computers, and other fixed display devices. In yet another aspect of one or more embodiments, the multiple channels of the ATSC 3.0 MPEG TS video feed transmission support interactive location services, custom advertisement insertion, and localized emergency notification services.

### BRIEF DESCRIPTION OF THE SEVERAL VIEWS OF THE DRAWINGS

The components in the drawings are not necessarily to scale relative to each other. Like reference numerals designate corresponding parts throughout the several views.

FIG. 1 is a system architecture diagram illustrating a system for a satellite-based content delivery system with an ATSC 3.0 transmitter and integrated satellite receiver, according to one example embodiment.

FIG. 2 is a system architecture diagram illustrating a system for a satellite-based content delivery system with multiple ATSC 3.0 transmitters and integrated satellite receivers, according to one example embodiment.

FIG. 3 is a system architecture diagram illustrating a ATSC 3.0 transmitter, according to one example embodiment.

FIG. 4A is a system architecture diagram illustrating a ATSC 3.0 transmitter and multiple End User ATSC 3.0 receiving devices, according to one example embodiment.

FIG. 4B is a system architecture diagram illustrating a ATSC 3.0 transmitter and multiple End User ATSC 3.0 receiving devices with Back Channel return paths, according to one example embodiment.

FIG. 5A is a system architecture diagram illustrating a system with an ATSC 3.0 Broadcast network and a 5G cellular Tower Network that connect to a Combination 5G+ATSC 3.0 Mobile Hotspot, according to one example embodiment.

FIG. 5B is a system architecture diagram illustrating a system with an ATSC 3.0 Broadcast network and a 5G cellular Tower Network that connect to a Combination 5G+ATSC 3.0 OBD2 Port for Vehicles, according to one example embodiment.

FIG. 5C is a system architecture diagram illustrating a system with an ATSC 3.0 Broadcast network and a 5G cellular Tower Network that connect to a Combination 5G+ATSC 3.0 Residential Gateway, according to one example embodiment.

FIG. 6 is a logic diagram showing a method for delivery of an ATSC 3.0 formatted signal via DBS satellite link for point to multi-point distribution.

FIG. 7 shows a system diagram that describes an example implementation of a computing system(s) for implementing embodiments described herein.

### DETAILED DESCRIPTION

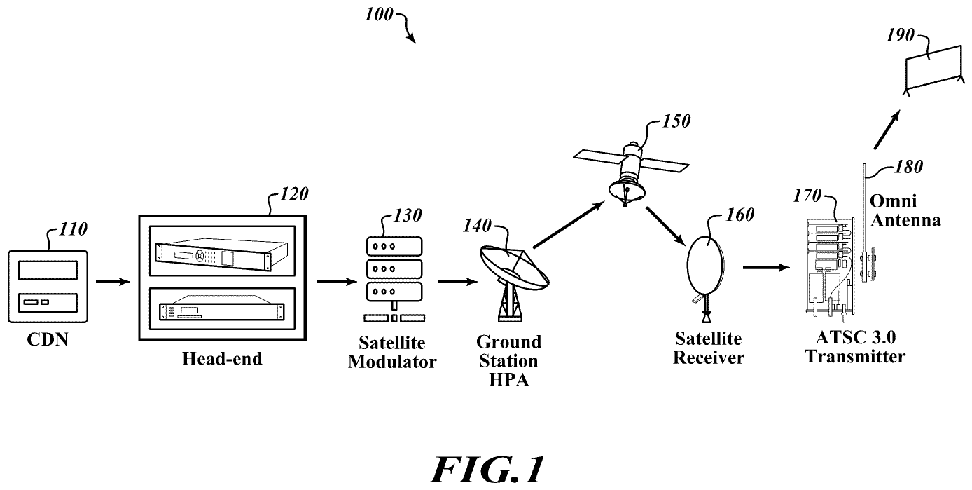

Each of the features and teachings disclosed herein may be utilized separately or in conjunction with other features and teachings to provide a system for delivery of an ATSC 3.0 formatted signal via DBS satellite link for point to multi-point distribution. Representative examples utilizing many of these additional features and teachings, both separately and in combination, are described in further detail with reference to the attached FIGS. 1-7. This detailed description is intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

As described above, ATSC 1.0 is the current Over-the-Air TV digital, broadcast standard in the United States. It launched in the U.S. in 2009 with the beginning of digital television. ATSC 1.0 covers the 54-598 MHz frequency range for TV broadcasters, who use it to broadcast, Over-the-Air TV stations in every Designated Mark Area (DMA).

The new standard is ATSC 3.0, which uses OFDM modulation and Internet Protocol to enhance the efficiency of the broadcast signal to deliver more services to customers than just HD 720p video to a fixed television. By using ATSC 3.0, 4K HDR video (which provides cinematic/immersive image detail, sharpness, depth and color) is also now possible, and apps other datacasting services can now be delivered using the same 6 MHz channel bandwidth used today for ATSC 1.0. In the ATSC 1.0 world today, most broadcasters rely on a single macro (large) broadcast tower to cover an entire city or town. ATSC 3.0 uses both macro and additional micro (smaller) towers.

Other user features of ATSC 3.0 include (1) High Dynamic Range (HDR), which provides enhanced image contrast, wide color gamut and color accuracy; (2) Robust Services to Mobile Devices, which provides OTA TV on phones, tablets and moving vehicles; (3) On Demand services that utilize two-way communication; (4) Audience (Viewing) Measurement, which provides direct measure audience viewing (no third party device); (5) Addressable Advertising/Companion Screens, which provide target customers with different advertising/content/second screen experiences; (6) Advanced Emergency Alert System (AWARN), which provides the ability to geotarget with additional emergency information; (7) Immersive Audio, which provides experience three-dimensional sound with 10 channels (7.1.2); and (8) IP Based Streaming, which maximizes bitrate efficiency and offers 2-way communication. Other ATSC 3.0 specifications include the use of (1) Low Density Parity Check (LDPC) codes; (2) multiple streams of Physical Layer Pipes; (3) Bitrate Mbps from <1 to 56 Mbps (Exp. ^{˜}28), (4) HEVC, H265, MPEG4 video encoding; (5) 120 frames per second frame rate; (6) MPEG-H or AC-4 audio; (7) MPEG Dynamic Adaptive Streaming over HTTP (DASH) for IP-Based Streaming; (8) Single Frequency Network SFN compatibility; and (9) mobile compatibility.

However, one of the challenges of tower installations is the need for fiber infrastructure to be in the ground, which is quite often not conveniently located to support the optimal placement of the tower. In some embodiments of the disclosure, this technologic challenge is overcome by leveraging use of satellite operations infrastructure instead of fiber in the ground. Thus, embodiments support broadcasters through the ability to broadcast signals on their behalf at any location that supports optimal tower placement.

As shown in FIG. 1, an ATSC 3.0 satellite-based content delivery system 100 is disclosed with an ATSC 3.0 transmitter and integrated satellite receiver. Specifically, the ATSC 3.0 satellite-based content delivery system 100 includes a Content Distribution Network (CDN) 110, a Head-End video distribution platform 120, a Satellite Modulator 130, a ground station High Power Amplifier (HPA) 140, a Satellite 150, a Satellite receiver 160, and an ATSC 3.0 transmitter 170 having an omni antenna 180. In the content delivery process, the CDN 110 distributes content (e.g., ATSC 3.0 MPEG Transport Stream (TS) video feed) to the Head-End platform 120. The Head-End platform 120 then sends ATSC 3.0 MPEG Transport Stream (TS) video feed to the Satellite Modulator 130 where the content is modulated. Specifically, the Modulator 130 encapsulates the ATSC 3.0 MPEG TS video feed into a DVB packet structure to be modulated onto a DVB-S2 carrier. The modulated content is next sent to the ground station HPA 140 where it is amplified to boost the signal level for uplink transmission to the Satellite 150. The Satellite 150 then sends the sends the encapsulated ATSC 3.0 MPEG TS video feed over a DVB-S2 carrier to the Satellite receiver 160. The Satellite receiver 160 has an integrated ATSC 3.0 transmitter 170 and an omni antenna 180.

The Satellite receiver 160 receives the encapsulated ATSC 3.0 MPEG TS video feed, and un-encapsulates the ATSC 3.0 MPEG TS video feed for use by the ATSC 3.0 transmitter 170. The ATSC 3.0 transmitter 170 and omni antenna 180 are used to transmit the ATSC 3.0 MPEG TS video feed to end user devices 190 that are ATSC 3.0 capable. The ATSC 3.0 MPEG TS video feed transmission includes multiple channels in a same transport stream. In one embodiment, one channel of the multiple channels is encoded with more error protection and less resolution for transmission to mobile devices and another channel in the multiple channels, which may have the same content is encoded with less error correction and higher resolution for fixed devices. The channel encoded for mobile distribution has a higher bitrate to support error correction for mobile connectivity, such as to a smartphone, vehicle, or laptop computer. The channel encoded for fixed distribution has a higher bitrate for fixed connectivity, such as to a television or desktop computer. In another embodiment, the multiple channels in the same transport stream support a different encoders (e.g., a first channel is a MPEG-4 channel that is more efficient and has greater capacity, and a second channel is a MPEG-2 channel that is supported by more legacy devices). The end users then view the ATSC 3.0 signal using ATSC 3.0 capable devices 190.

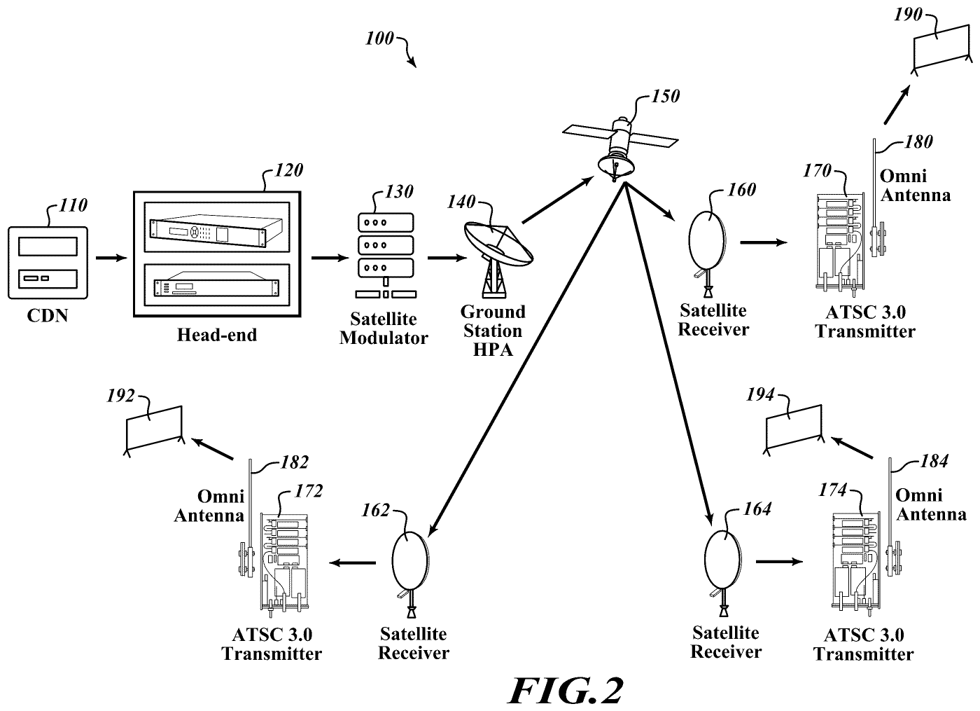

As shown in FIG. 2, most satellite-based content delivery systems 100 have multiple satellite receivers 160, 162, 164 and integrated ATSC 3.0 transmitters 170, 172, 174. Accordingly, the ATSC 3.0 satellite-based content delivery system 100 includes a Content Distribution Network (CDN) 110, a Head-End video distribution platform 120, a Satellite Modulator 130, a ground station High Power Amplifier (HPA) 140, a Satellite 150, a multiple Satellite receivers 160, 162, 164, and multiple ATSC 3.0 transmitters 170, 172, 174, each having an omni antenna 180, 182, 184. Similar to the content delivery process described in FIG. 1, the CDN 110 distributes content (e.g., ATSC 3.0 MPEG Transport Stream (TS) video feed) to the Head-End platform 120. The Head-End platform 120 then sends the ATSC 3.0 MPEG Transport Stream (TS) video feed to the Satellite Modulator 130 where the content is modulated. Specifically, the Modulator 130 encapsulates the ATSC 3.0 MPEG TS video feed into a DVB packet structure to be modulated onto a DVB-S2 carrier. The modulated content is next sent to the ground station HPA 140 where it is amplified to boost the signal level for uplink transmission to the Satellite 150.

As shown in FIG. 2, the Satellite 150 then sends the encapsulated ATSC 3.0 MPEG TS video feed over a DVB-S2 carrier to multiple satellite receivers 160, 162, 164 at distributed locations. The multiple Satellite receivers 160, 162, 164 each have an integrated ATSC 3.0 transmitter 170, 172, 174 and an omni antenna 180, 182, 184. The multiple satellite receivers 160, 162, 164 at distributed locations each receive the encapsulated ATSC 3.0 MPEG TS video feed, and un-encapsulate the ATSC 3.0 MPEG TS video feed for use by the multiple ATSC 3.0 transmitters 170, 172, 174. The multiple ATSC 3.0 transmitters 170, 172, 174 and multiple omni antenna 180, 182, 184 are used to transmit the ATSC 3.0 signal to end user devices 190 that are ATSC 3.0 capable. The ATSC 3.0 MPEG TS video feed transmission includes multiple channels in a same transport stream.

The end users then view the ATSC 3.0 signal using ATSC 3.0 capable devices 190, 192, 194. The ATSC 3.0 end user devices include mobile devices such as smartphones, laptop computers, and mobile vehicles via an OBD2 port, televisions, desktop computers, and other fixed display devices. In some embodiments, the transmission of the ATSC 3.0 MPEG TS video feed to the ATSC 3.0 end user devices 190, 192, 194 employs ATSC 3.0 repeaters. In one or more embodiments of the ATSC 3.0 satellite-based content delivery system 100, the multiple channels of the ATSC 3.0 MPEG TS video feed transmission support one or more of interactive location services, custom advertisement insertion, and localized emergency notification services.

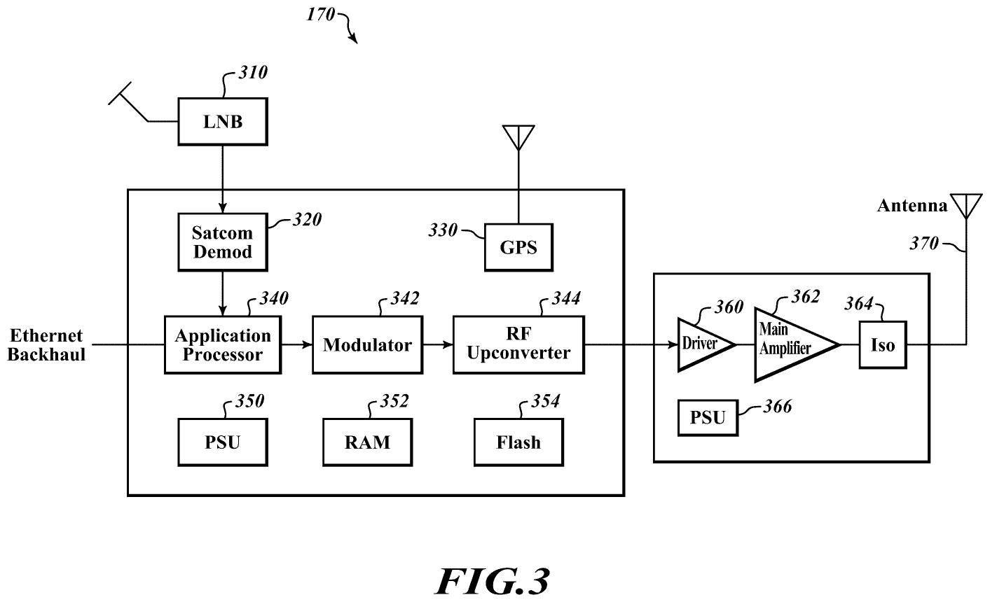

Referring now to FIG. 3, an ATSC 3.0 transmitter block 170 is shown that includes a Low-Noise Block Downconverter (LNB) 310 and an isotropic (i.e., omni-directional) antenna 370 for a ATSC 3.0 satellite-based content delivery system 100. In some embodiments, the antenna 370 is the same as the antennas 180, 182, 184. The LNB 310 is the receiving device used for satellite TV reception. The LNB 310 of the ATSC 3.0 transmitter block 170 includes a Satcom Demodulator 320, a Global Positioning System (GPS) 330, an application processor 340, a modulator 342, a Radio Frequency (RF) upconverter 344, a Power Supply Unit (PSU) 350, Random Access Memory (RAM) 352, Flash Memory 354. Additionally, the Antenna 370 includes a driver 360, a Main Amplifier 362, an ISO 364, and a Power Supply Unit (PSU) 366.

In some embodiments of the ATSC 3.0 satellite-based content delivery system 100, the ATSC 3.0 provides enhanced features and overcome various technological limitations of previous system. In some embodiments of the ATSC 3.0 satellite-based content delivery system 100, ATSC 3.0 OTA TV services are provided to customers in conjunction with consumer mobile 5G hotspot, a 5G Wi-Fi Router in the home, or 5G in-building coverage devices. Such systems have the ability to dynamically leverage both ATSC 3.0 and 5G networks, use multiple layer pipes for different services, and utilize satellite infrastructure as a front haul option to source content (e.g., ATSC 3.0 MPEG TS video feed). In one such embodiment, a combination ATSC 3.0 and 5G distribution system of the ATSC 3.0 satellite-based content delivery system 100 has the ability to provide mobility cellular service along with high-data rate video content (e.g., 4K video).

In some such embodiments of the ATSC 3.0 satellite-based content delivery system 100, the ATSC 3.0 signal protocol is standard IP multicast datagrams that meet the ATSC 3.0 specifications. The ATSC 3.0 multicast stream is encapsulated into a DVB packet structure and then modulated onto a DVB-S2 carrier. In one embodiment of the ATSC 3.0 satellite-based content delivery system 100, a satellite link traverses a satellite spacecraft 150 located at an orbital slot (e.g., 77 West orbital slot). In one or more embodiments of the content delivery process, a DVB-S2 capable satellite receiver 160 is used to de-encapsulated the DVB packet structure back to the native ATSC 3.0 IP multicast packets. The recovered ATSC 3.0 multicast stream is then provided to an ATSC 3.0 exciter in a ATSC 3.0 transmitter 170 that feeds the ATSC 3.0 RF waveform to a high-power amplifier for over the air transmission. In one embodiment, the DVB-S2 receiver 160 which converts the DVB packet structure back to ATSC 3.0, uses a 5 Watt transmission unit for low power ATSC 3.0 over the air transmissions. In another aspect of one embodiment, an uplink may implement a 600 Watt ATSC 3.0 OTA transmission mobile reception.

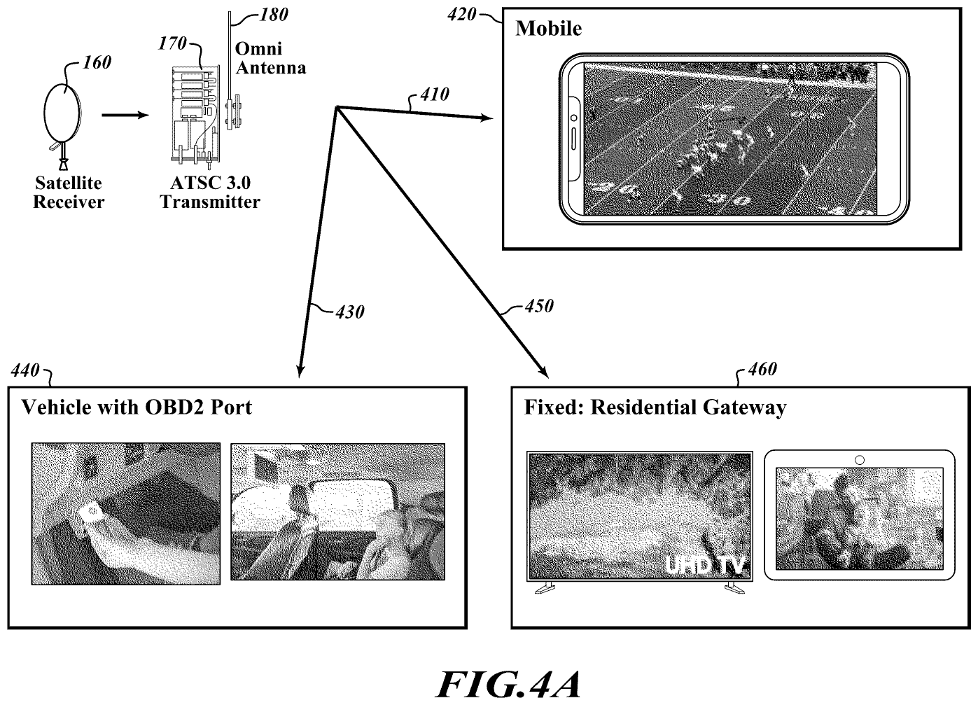

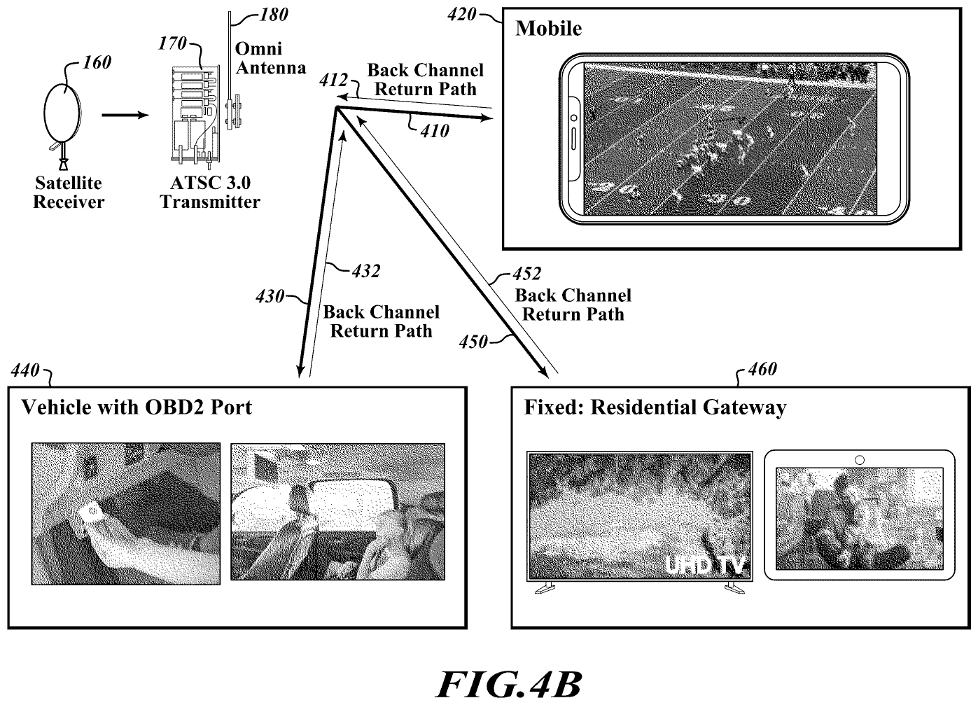

Referring now to FIG. 4A, a satellite receiver 160 and ATSC 3.0 transmitter 170 of the ATSC 3.0 satellite-based content delivery system 100 are shown. The ATSC 3.0 transmitter 170 sends transmissions (e.g., ATSC 3.0 RF waveforms) out to multiple end user ATSC 3.0 receiving devices. Specifically, ATSC 3.0 transmitter 170 sends transmissions 410 to mobile 5G cellular devices 420. In some embodiments, the ATSC 3.0 transmitter 170 also sends transmissions 430 to devices connected with OBD2 Port-enabled vehicles 440. In still other embodiments, the ATSC 3.0 transmitter 170 sends transmissions 450 to fixed residential gateway devices 460.

Referring now to FIG. 4B, a satellite receiver 160 and ATSC 3.0 transmitter 170 of the ATSC 3.0 satellite-based content delivery system 100 are again shown; however, in this embodiment, not only does the ATSC 3.0 transmitter 170 send transmissions (e.g., ATSC 3.0 RF waveforms) out to multiple end user ATSC 3.0 receiving devices, but in this embodiment the multiple end user ATSC 3.0 receiving devices transmit signals to the ATSC 3.0 transmitter 170 over back channel return paths. A back channel return path supports communication back from the ATSC 3.0 receiving devices to the ATSC 3.0 transmitter 170 (and potentially all the way back to the content provider). Otherwise stated, the back channel return path supports two way communication between the ATSC 3.0 transmitter 170 and the ATSC 3.0 receiving devices. Accordingly, a back channel return path is used by interactive television, live wagering for a sporting event, live product ordering services, and the like. Specifically, ATSC 3.0 transmitter 170 sends transmissions 410 to mobile 5G cellular devices 420, and the mobile 5G cellular devices 420 send transmissions back by back channel return path 412. In some embodiments, the ATSC 3.0 transmitter 170 also sends transmissions 430 to devices connected with OBD2 Port-enabled vehicles 440, and the devices connected with OBD2 Port-enabled vehicles 440 send transmissions back by back channel return path 432. In still other embodiments, the ATSC 3.0 transmitter 170 sends transmissions 450 to fixed residential gateway devices 460, and the fixed residential gateway devices 460 send transmissions back by back channel return path 452. In one or more embodiments of the ATSC 3.0 satellite-based content delivery system 100, the back channel return path 412, 432, 452 employs IP encapsulation of data with a return path via 5G cellular.

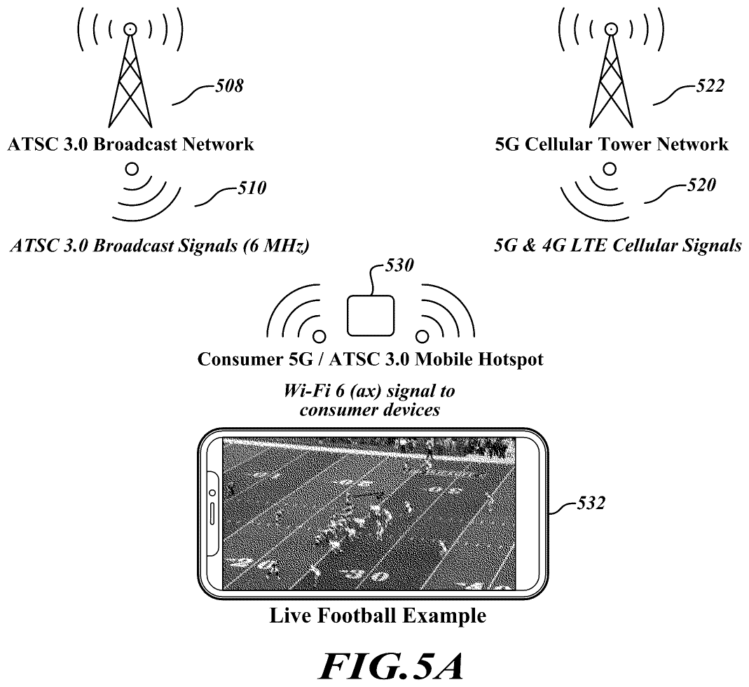

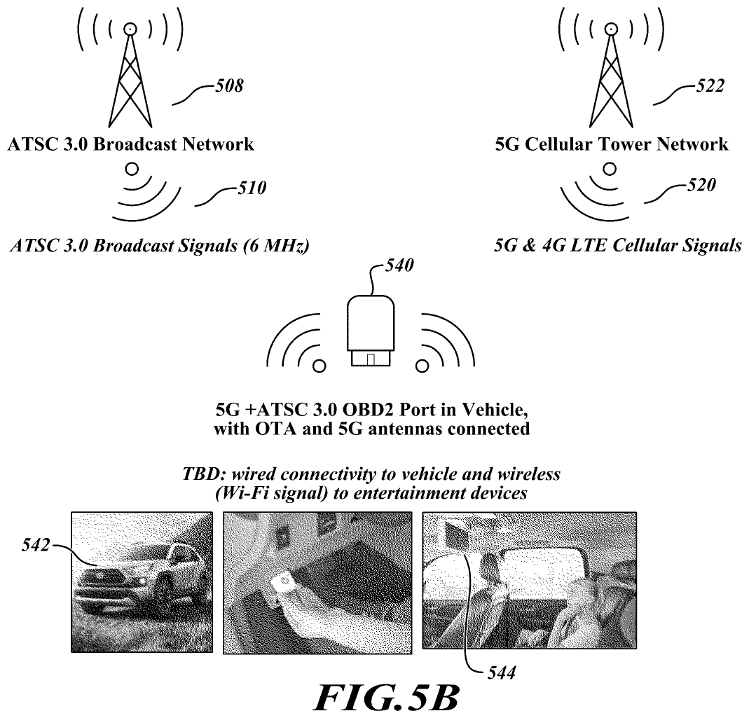

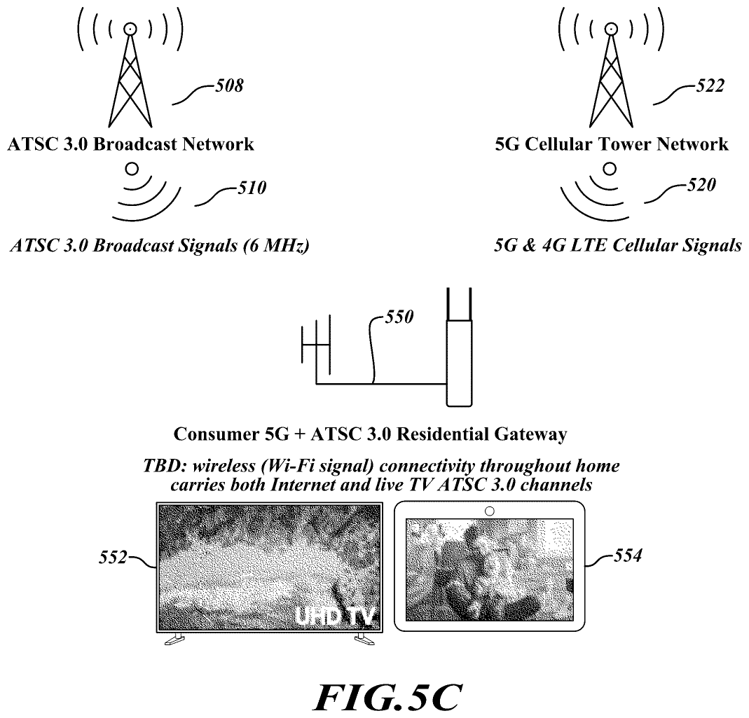

Referring now to FIG. 5A, an embodiment of an ATSC 3.0 satellite-based content delivery system 100 is shown with an ATSC 3.0 Broadcast network 508 and a 5G cellular Tower Network 522 that connect to a support a combination 5G+ATSC 3.0 Mobile Hotspot 530, which may be provided on a user's smart phone 532. In one such embodiment of the ATSC 3.0 satellite-based content delivery system 100, the ATSC 3.0 broadcast signal 510 (i.e., MPEG TS video feed) is combined with 5G cellular signals 520 (from the 5G cellular network 522) in a combination 5G+ATSC 3.0 mobile hotspot 530. The mobile hotspot 530 provides service for a user's smart phone 532, laptop computer (not shown), or other mobile computing device (not shown). In such an embodiment, both the ATSC 3.0 broadcast signal 510 and the 5G cellular signals 520 are sent from the mobile hotspot 530 to the end user devices 532.

In the embodiment shown in FIG. 5A, the mobile hotspot 530 is being used to support the viewing of a live football game on an ATSC 3.0 Broadcast network 508. In some embodiments of the ATSC 3.0 satellite-based content delivery system 100, embodiments provide ATSC 3.0 Over-the-Air TV services in conjunction with 5G wireless cellular services. There are often potential service customers that are in need of a 5G mobile hotspot. In one or more embodiments of the ATSC 3.0 satellite-based content delivery system 100, a combination 5G+ATSC 3.0 mobile hotspot 530 is incorporated into the system.

The combination 5G+ATSC 3.0 mobile hotspot of the ATSC 3.0 satellite-based content delivery system 100 offers a unique, combined set of features, by leveraging the ATSC 3.0 capabilities. These enhanced features and technological capabilities include expanded signal coverage, faster download speeds, free live TV channels (e.g., prime time networks including 4K and mobile viewing content), on-demand video, apps, and data usage savings by offloading content from 5G cellular networks 522 onto ATSC 3.0 networks 508. This data usage savings by offloading content is similar to how a customer saves 5G cellular data usage by connecting to a free Wi-Fi hotspot.

The disclosed embodiments of the ATSC 3.0 satellite-based content delivery system 100 that include a combination 5G+ATSC 3.0 mobile hotspot 530, offer a mobile hotspot that simultaneously provides traditional cellular networks plus the broadcasting features of ATSC 3.0. Such broadcasting features of ATSC 3.0 include free HD local channels (e.g., ABC, CBS, FOX, NBC, etc.), 4K live and on-demand video, TV apps and widgets, and offload data usage from 5G network onto ATSC 3.0 network (e.g., offline Netflix). Lastly, in some embodiments of the ATSC 3.0 satellite-based content delivery system 100 that include a combination 5G+ATSC 3.0 mobile hotspot 530, the system supports new mobile services such as Offline Netflix or YouTube, where the connection to Netflix or YouTube is made using ATSC 3.0 networks 508 rather than 5G cellular networks 522.

Referring now to FIG. 5B, an embodiment of an ATSC 3.0 satellite-based content delivery system 100 is shown with an ATSC 3.0 Broadcast network 508 and a 5G cellular Tower Network 522 that connect to a support a combination 5G+ATSC 3.0 OBD2 Port 540 for vehicles 542 with OTA and 5G antennas connected. In one such embodiment of the ATSC 3.0 satellite-based content delivery system 100, the ATSC 3.0 broadcast signal 510 (i.e., MPEG TS video feed) is combined with 5G cellular signals 520 (from a 5G cellular network 522) in a combination 5G+ATSC 3.0 OBD2 port 540 in a vehicle 542. The ATSC 3.0 OBD2 port 540 in the vehicle 542 may be used to support wired connectivity to the vehicle and wireless (Wi-Fi signal) connectivity to entertainment devices 544 in the vehicle. In such an embodiment, both the ATSC 3.0 broadcast signal 510 and the 5G cellular signals 520 are sent from the OBD2 port 540 to the devices 544 in the vehicle 542.

In the embodiment shown in FIG. 5B, the combination 5G+ATSC 3.0 OBD2 Port 540 is being used to support wired connectivity to the vehicle 542 and wireless (Wi-Fi signal) to entertainment devices 544 in the vehicle. In some embodiments of the ATSC 3.0 satellite-based content delivery system 100, embodiments provide Over-the-Air TV services in conjunction with 5G wireless cellular services. Such services includes enabling customers to watch TV while in a moving vehicle.

In one or more embodiments of the ATSC 3.0 satellite-based content delivery system 100, a combination 5G+ATSC 3.0 OBD2 port 540 offers automotive OEMs, dealerships, and end customers who need connectivity in their vehicles, a unique, combined set of features, by leveraging the ATSC 3.0 capabilities. These enhanced features and technological capabilities include expanded signal coverage, faster download speeds, free live TV channels from prime time networks including 4K and mobile viewing content, on-demand video, apps, and data usage savings by offloading content from 5G cellular networks 522 onto ATSC 3.0 networks 508. This data usage savings by offloading content is similar to how a customer saves data usage whenever the connect to a free Wi-Fi hotspot.

The disclosed embodiments of the ATSC 3.0 satellite-based content delivery system 100 that include a combination 5G+ATSC 3.0 OBD2 port 540 for a vehicle 544, offer a vehicular connectivity solution that simultaneously provides traditional cellular networks plus the broadcasting features of ATSC 3.0. As described above, such broadcasting features of ATSC 3.0 include free HD local channels (ABC, CBS, FOX, NBC, etc.), 4K live and on-demand video, TV apps and widgets, and offload data usage from 5G network onto ATSC 3.0 network (e.g., offline Netflix). Lastly, in some embodiments of the ATSC 3.0 satellite-based content delivery system 100 that include a combination 5G+ATSC 3.0 OBD2 port 540, the system supports new mobile services such as Offline Netflix or YouTube, where the connection to Netflix or YouTube is made using ATSC 3.0 networks 508 rather than 5G cellular networks 522.

Referring now to FIG. 5C, an embodiment of an ATSC 3.0 satellite-based content delivery system 100 is shown with an ATSC 3.0 Broadcast network 508 and a 5G cellular Tower Network 522 that connect to a combination 5G+ATSC 3.0 Residential Gateway 550, such as a user's fixed home computer 552 and television devices 554. In one such embodiment of the ATSC 3.0 satellite-based content delivery system 100, the ATSC 3.0 broadcast signal 510 (i.e., MPEG TS video feed) is combined with 5G cellular signals 520 (from a 5G cellular network 522) in a combination 5G+ATSC 3.0 Residential Gateway 550. The Residential Gateway 550 provides fixed connectivity service for a user's home computer 552 and television devices 554. In such an embodiment, both the ATSC 3.0 broadcast signal 510 and the 5G cellular signals 520 are sent from the Residential Gateway 550 to end user devices 552, 554.

In the embodiment shown in FIG. 5C, the Residential Gateway 550 is being used to support the viewing of live television on an ATSC 3.0 Broadcast network 508 as well as 5G cellular network 522 on end user devices 552, 554. In some embodiments of the ATSC 3.0 satellite-based content delivery system 100, embodiments provide Over-the-Air TV services in conjunction with 5G wireless cellular services. Such services include enabling customers to have a 5G residential gateway for fixed wireless access Internet. The combination 5G+ATSC 3.0 residential gateway 540 of the ATSC 3.0 satellite-based content delivery system 100 offers users who need fixed wireless Internet access, a unique, combined set of features, by leveraging the ATSC 3.0 capabilities. These enhanced features and technology include expanded signal coverage, faster download speeds, free live TV channels from prime time networks including 4K and mobile viewing content, on-demand video, apps, and data usage savings by offloading content from 5G cellular networks 522 onto ATSC 3.0 networks 508. This data usage savings by offloading content is similar to how a customer saves data usage whenever the connect to a free Wi-Fi hotspot.

The disclosed embodiments of the ATSC 3.0 satellite-based content delivery system 100 that include a combination 5G+ATSC 3.0 residential gateway 540, offer a connectivity solution that simultaneously provides 5G fixed wireless access plus the broadcasting features of ATSC 3.0. Again, as described above, such broadcasting features of ATSC 3.0 include free HD local channels (ABC, CBS, FOX, NBC, etc.), 4K live and on-demand video, TV apps and widgets, and offload data usage from 5G cellular network 522 onto ATSC 3.0 network 508 (e.g., offline Netflix).

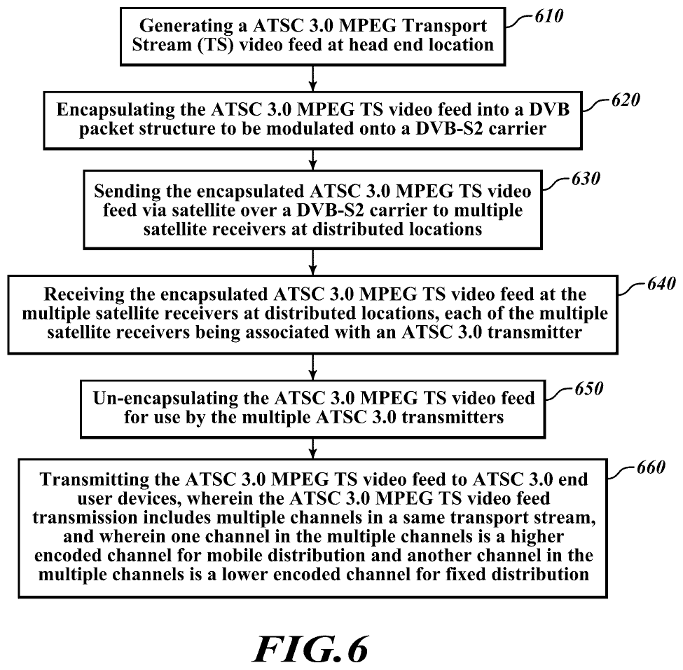

FIG. 6 is a logic diagram showing a method for delivery of an ATSC 3.0 formatted signal via DBS satellite link for point to multi-point distribution. As shown in FIG. 6, at operation 610, the method generates an ATSC 3.0 MPEG Transport Stream (TS) video feed at head end location. At operation 620, the method encapsulates the ATSC 3.0 MPEG TS video feed into a DVB packet structure to be modulated onto a DVB-S2 carrier. At operation 630, the method sends the encapsulated ATSC 3.0 MPEG TS video feed via satellite over a DVB-S2 carrier to multiple satellite receivers at distributed locations. At operation 640, the method receives the encapsulated ATSC 3.0 MPEG TS video feed at the multiple satellite receivers at distributed locations, each of the multiple satellite receivers being associated with an ATSC 3.0 transmitter. At operation 650, the method un-encapsulates the ATSC 3.0 MPEG TS video feed for use by the multiple ATSC 3.0 transmitters. At operation 660, the method transmits the ATSC 3.0 MPEG TS video feed to ATSC 3.0 end user devices. The ATSC 3.0 MPEG TS video feed transmission includes multiple channels in a same transport stream. Additionally, one channel in the multiple channels is a higher encoded channel for mobile distribution and another channel in the multiple channels is a lower encoded channel for fixed distribution.

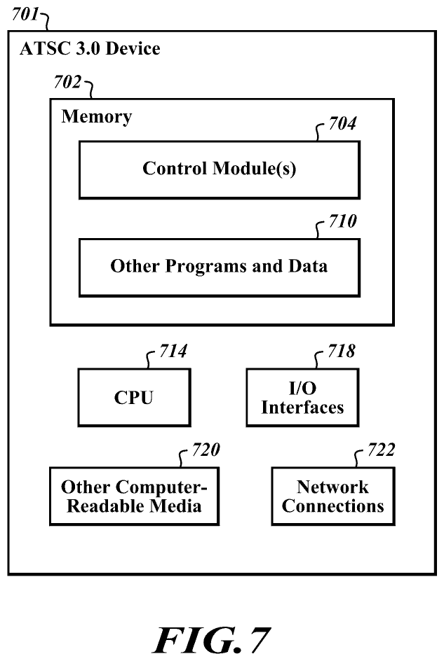

FIG. 7 shows a system diagram that describes an example implementation of a computing system(s) for implementing embodiments described herein. The functionality described herein relates to a system for delivery of an ATSC 3.0 formatted signal via DBS satellite link for point to multi-point distribution that can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility.

In particular, shown are example host computer system(s) 701. For example, such computer system(s) 701 may represent those in various data centers and cell sites shown and/or described herein that host the functions, components, microservices and other aspects described herein to implement delivery of an ATSC 3.0 formatted signal via DBS satellite link for point to multi-point distribution. In some embodiments, one or more special-purpose computing systems may be used to implement the functionality described herein. Accordingly, various embodiments described herein may be implemented in software, hardware, firmware, or in some combination thereof. Host computer system(s) 701 may include memory 702, one or more central processing units (CPUs) 714, I/O interfaces 718, other computer-readable media 720, and network connections 722.

Memory 702 may include one or more various types of non-volatile and/or volatile storage technologies. Examples of memory 702 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 702 may be utilized to store information, including computer-readable instructions that are utilized by CPU 714 to perform actions, including those of embodiments described herein.

Memory 702 may have stored thereon control module(s) 704. The control module(s) 704 may be configured to implement and/or perform some or all of the functions of the systems, components and modules described herein for delivery of an ATSC 3.0 formatted signal via DBS satellite link for point to multi-point distribution. Memory 702 may also store other programs and data 710, which may include rules, databases, application programming interfaces (APIs), software platforms, cloud computing service software, network management software, network orchestrator software, network functions (NF), Al or ML programs or models to perform the functionality described herein, user interfaces, operating systems, other network management functions, other NFs, etc.

Network connections 722 are configured to communicate with other computing devices to facilitate the functionality described herein. In various embodiments, the network connections 722 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 718 may include a video interface, other data input or output interfaces, or the like. Other computer-readable media 720 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for delivery of an Advanced Television Systems Committee (ATSC) 3.0 formatted signal via Direct Broadcast Satellite (DBS) satellite link for point to multi-point distribution, the method comprising:
generating ATSC 3.0 Moving Picture Experts Group (MPEG) Transport Stream (TS) video feed at a head end location;
encapsulating the ATSC 3.0 MPEG TS video feed into a DVB packet structure to be modulated onto a Digital Video Broadcasting Satellite Second Generation (DVB-S2) carrier;
sending the encapsulated ATSC 3.0 MPEG TS video feed via satellite over a DVB-S2 carrier to multiple satellite receivers at distributed locations;
receiving the encapsulated ATSC 3.0 MPEG TS video feed at the multiple satellite receivers at distributed locations, each of the multiple satellite receivers being associated with an ATSC 3.0 transmitter;
un-encapsulating the ATSC 3.0 MPEG TS video feed for use by multiple ATSC 3.0 transmitters; and
transmitting the ATSC 3.0 MPEG TS video feed to ATSC 3.0 end user devices, wherein the ATSC 3.0 MPEG TS video feed transmission includes multiple channels in a same transport stream, and wherein one channel of the multiple channels is encoded with more error protection and less resolution for transmission to mobile devices and another channel in the multiple channels, which may have the same content is encoded with less error correction and higher resolution for fixed devices.

2. The method of claim 1, wherein the transmission of the ATSC 3.0 MPEG TS video feed to the ATSC 3.0 end user devices employs Orthogonal Frequency-Division Multiplexing (OFDM).

3. The method of claim 1, wherein the transmission of the ATSC 3.0 MPEG TS video feed to the ATSC 3.0 end user devices employs ATSC 3.0 repeaters.

4. The method of claim 1, wherein the transmission of the ATSC 3.0 MPEG TS video feed to the ATSC 3.0 end user devices supports MPEG-4 encoding.

5. The method of claim 1, wherein each ATSC 3.0 transmitter includes an omni-directional antenna.

6. The method of claim 1, wherein at least one channel in the multiple channels is a back channel that supports a return path from an ATSC 3.0 end user device to an associated ATSC 3.0 transmitter.

7. The method of claim 6, wherein the back channel employs IP encapsulation of data with a return path via 5G cellular.

8. The method of claim 1, wherein the ATSC 3.0 end user devices include mobile devices including one or more of smartphones, laptop computers, and mobile vehicles via an OBD2 port, and wherein the ATSC 3.0 end user devices include fixed devices including one or more of televisions, desktop computers, and other fixed display devices.

9. The method of claim 1, wherein the multiple channels of the ATSC 3.0 MPEG TS video feed transmission support interactive location services, custom advertisement insertion, and localized emergency notification services.

10. A system for delivery of an Advanced Television Systems Committee (ATSC) 3.0 formatted signal via Direct Broadcast Satellite (DBS) satellite link for point to multi-point distribution, the system comprising:
a head end video distribution platform that generates a ATSC 3.0 Moving Picture Experts Group (MPEG) Transport Stream (TS) video feed;
a modulator that receives the ATSC 3.0 MPEG TS video feed from the head end video distribution platform, the modulator encapsulating the ATSC 3.0 MPEG TS video feed into a Digital Video Broadcasting (DVB) packet structure on a Digital Video Broadcasting Satellite Second Generation (DVB-S2) carrier;
a ground station High Power Amplifier that receives the encapsulated ATSC 3.0 MPEG TS video feed in the DVB packet structure from the modulator, the ground station High Power Amplifier sending the encapsulated ATSC 3.0 MPEG TS video feed via satellite over DVB-S2 carrier;
multiple satellite receivers at distributed locations that receive the encapsulated ATSC 3.0 MPEG TS video feed, each of the multiple satellite receivers un-encapsulating the ATSC 3.0 MPEG TS video feed received from the satellite over the DVB-S2 carrier; and
multiple ATSC 3.0 transmitters, wherein each ATSC 3.0 transmitter is associated with one of the multiple satellite receivers, each ATSC 3.0 transmitter transmitting the ATSC 3.0 MPEG TS video feed to ATSC 3.0 end user devices, wherein the ATSC 3.0 MPEG TS video feed transmission includes multiple channels in a same transport stream, and wherein one channel of the multiple channels is encoded with more error protection and less resolution for transmission to mobile devices and another channel in the multiple channels, which may have the same content is encoded with less error correction and higher resolution for fixed devices.

11. The system of claim 10, wherein the transmission of the ATSC 3.0 MPEG TS video feed to the ATSC 3.0 end user devices employs Orthogonal Frequency-Division Multiplexing (OFDM).

12. The system of claim 10, wherein the transmission of the ATSC 3.0 MPEG TS video feed to the ATSC 3.0 end user devices employs ATSC 3.0 repeaters.

13. The system of claim 10, wherein the transmission of the ATSC 3.0 MPEG TS video feed to the ATSC 3.0 end user devices supports MPEG-4 encoding.

14. The system of claim 10, wherein each ATSC 3.0 transmitter includes an omni-directional antenna.

15. The system of claim 10, wherein at least one channel in the multiple channels is a back channel that supports a return path from an ATSC 3.0 end user device to an associated ATSC 3.0 transmitter.

16. The system of claim 15, wherein the back channel employs IP encapsulation of data with a return path via 5G cellular.

17. The system of claim 10, wherein the ATSC 3.0 end user devices include mobile devices including one or more of smartphones, laptop computers, and mobile vehicles via an OBD2 port, and wherein the ATSC 3.0 end user devices include fixed devices including one or more of televisions, desktop computers, and other fixed display devices.

18. The system of claim 10, wherein the multiple channels of the ATSC 3.0 MPEG TS video feed transmission support interactive location services, custom advertisement insertion, and localized emergency notification services.

19. A system comprising:
a ground station High Power Amplifier that receives the encapsulated Advanced Television Systems Committee (ATSC) 3.0 Moving Picture Experts Group (MPEG) Transport Stream (TS) video feed in the Digital Video Broadcasting (DVB) packet structure from the modulator, the ground station High Power Amplifier sending the encapsulated ATSC 3.0 MPEG TS video feed via satellite over a Digital Video Broadcasting Satellite Second Generation (DVB-S2) carrier;
multiple satellite receivers at distributed locations that receive the encapsulated ATSC 3.0 MPEG TS video feed, each of the multiple satellite receivers un-encapsulating the ATSC 3.0 MPEG TS video feed received from the satellite over the DVB-S2 carrier; and
multiple ATSC 3.0 transmitters, wherein each ATSC 3.0 transmitter is associated with one of the multiple satellite receivers, each ATSC 3.0 transmitter transmitting the ATSC 3.0 MPEG TS video feed to ATSC 3.0 end user devices, wherein the ATSC 3.0 MPEG TS video feed transmission includes multiple channels in a same transport stream, and wherein one channel of the multiple channels is encoded with more error protection and less resolution for transmission to mobile devices and another channel in the multiple channels, which may have the same content is encoded with less error correction and higher resolution for fixed devices.

20. The system of claim 19, wherein at least one channel in the multiple channels is a back channel that supports a return path from an ATSC 3.0 end user device to the associated ATSC 3.0 transmitter.
